(19) United States
(12) Patent Application Publication
(10) Pub. No.: US 2013/0114087 A1
(43) Pub. Date: May 9, 2013

(54) LOW COHERENCE INTERFEROMETRY USING ENCODER SYSTEMS

(71) Applicant: Zygo Corporation, Middlefield, CT (US)

(72) Inventor: Leslie L. Deck, Middletown, CT (US)

(73) Assignee: ZYGO CORPORATION, Middlefield, CT (US)

(21) Appl. No.: 13/671,807

(22) Filed: Nov. 8, 2012

Related U.S. Application Data
(60) Provisional application No. 61/557,520, filed on Nov. 9, 2011.

(51) Int. Cl. G01B 11/14

(52) U.S. Cl. 356/486; 356/498

(57) ABSTRACT

A method for determining information about changes in a position of an encoder scale includes separating, in a first interferometry cavity, a low coherence beam into a first beam propagating along a first path of the first interferometry cavity and a second beam propagating along a second path of the first interferometry cavity, combining the first beam and the second beam to form a first output beam, separating, in a second interferometry cavity, the first output beam into a measurement beam propagating along a measurement path of the second interferometry cavity and a reference beam propagating along a reference path of the second interferometry cavity, combining the measurement beam and the reference beam to form a second output beam, detecting an interference signal based on the second output beam, and determining the information about changes in the position of the encoder scale based on phase information from the interference signal.

### CROSS-REFERENCE TO RELATED APPLICATIONS

This application claims priority to Provisional Application No. 61/557,520, filed on Nov. 9, 2011, the contents of which are hereby incorporated by reference in their entirety.

### BACKGROUND

Optical encoders measure distance and motion by optically reading a graduated scale. Unlike optical distance measuring interferometers (DMI), the scale graduations define the basic unit of length, rather than the wavelength of light. The interferometer used to read the scale (the encoder read-head) is usually in close proximity to the scale to minimize turbulence. The read-head directs light to the scale and recovers one or more of the diffracted orders to determine the motion along the plane of the scale. The close proximity of the read-head to the scale can result in unwanted diffraction orders being intercepted by the read-head, leading to measurement errors. For example, 2D scales produce diffracted orders along 4 directions. When coherent light (e.g., laser light) is used, reflections from these extra beams or ghost beams reflecting off other optical interfaces can interfere with the measurement beam and cause a measurement error. Although the geometry of encoder system can be configured to block some of these unwanted beams, it is very difficult to anticipate all ghost beams, particularly if either the grating or read-head is in dynamic motion, since ghost beams produced by multiple reflections can still cause measurable error and stage motion can dynamically change the direction of the ghost beams.

### SUMMARY

The subject matter of the present disclosure relates to low coherence interferometry using an encoder system. The encoder system can be used to minimize or eliminate unwanted ghost beams through the use of low coherent illumination and coupled-cavity architecture. The encoder system includes a low coherence source and two interferometer cavities coupled together in series. One of the coupled cavities encodes heterodyne modulation and defines a system optical path difference (OPD). The other cavity includes a read-head interferometer. This combination is particularly useful for encoders since the motion range perpendicular to the scale plane is limited. By selecting the source coherence to just encompass this range, ghosts whose optical paths exceed this range no longer coherently interfere with the test beam and are rejected electronically.

Various aspects of the invention are summarized as follows.

In general, in a first aspect, the present disclosure features methods for determining information about changes in a position of an encoder scale, in which the methods include separating, in a first interferometry cavity, a low coherence beam into a first beam propagating along a first path of the first interferometry cavity and a second beam propagating along a second path of the first interferometry cavity; combining the first beam and the second beam to form a first output beam; separating, in a second interferometry cavity, the first output beam into a measurement beam propagating along a measurement path of the second interferometry cavity and a reference beam propagating along a reference path of the second interferometry cavity; combining the measurement beam and the reference beam to form a second output beam; detecting an interference signal based on the second output beam; and determining the information about changes in the position of the encoder scale based on phase information from the interference signal.

Implementations of the methods can include one or more of the following features and/or features of other aspects. For example, the methods can include adjusting an optical path difference (OPD) associated with the second interferometry cavity. Adjusting the OPD associated with the second interferometry cavity can include setting the OPD associated with the second interferometry cavity approximately equal to an OPD associated with the first interferometry cavity. A difference between the OPD associated with the second interferometry cavity and the OPD associated with the first interferometry cavity can be less than or equal to a coherence length of the low coherence beam. Adjusting the OPD associated with the second interferometry cavity can include adjusting an optical path length (OPL) of at least one of the measurement path or the reference path. Each of the OPD associated with first cavity and the OPD associated with the second cavity can be greater than a coherence length of the low coherence beam. In some embodiments, the OPD of the first cavity is equal to a difference between an optical path length (OPL) of the first path and an OPL of the second path, the OPL of the second path being different from the OPL of the first path.

The methods can include directing the measurement beam toward the encoder scale prior to combining the measurement beam and the reference beam, in which the measurement beam diffracts from the encoder scale at least once. The methods can include shifting a frequency of at least one of the first beam or the second beam in the first interferometry cavity. The second output beam can include a heterodyne frequency, the heterodyne frequency being equal to a difference between the frequency of the first beam and the frequency of the second beam after shifting the frequency of at least one of the first beam or the second beam.

In general, in another aspect, the invention features an interferometry system including a low coherence illumination source; a first interferometer cavity coupled to the low coherence illumination source to receive an output of the illumination source, the first interferometer cavity being associated with a first optical path difference (OPD); and a second interferometer cavity coupled to the first interferometer cavity to receive an output of the first interferometer cavity, the second interferometry cavity being associated with a second OPD.

Embodiments of the interferometry system can include one or more of the following features and/or features of other aspects. For example, the first OPD can be constant. In some embodiments, the second OPD is adjustable.

A difference between the first OPD and the second OPD can be less than a coherence length (CL) of an output of the low coherence illumination source. Each of the first OPD and the second OPD is greater than a coherence length (CL) of the output of the illumination source. The first OPD can be approximately equal to the second OPD.

The first cavity can include a first leg having a first optical path length (OPL) and a second leg having a second different OPL, the OPD of the first cavity being equal to the difference between the first OPL and the second OPL.

The first cavity can include a frequency shifting device in the first leg, the frequency shifting device being configured to shift a frequency of light in the first leg during operation of the interferometry system. The frequency shifting device can include an acousto-optical modulator or an electro-optical phase modulator.

The second cavity comprises a first leg having a first optical path length (OPL) and a second leg having a second OPL, the OPD of the second cavity being equal to a difference between the first OPL and the second OPL. At least one of the first OPL and the second OPL can be adjustable. The first leg can corresponds to a measurement path and the second leg corresponds to a reference path. The second cavity can include a diffractive encoder scale, each of the first OPL and the second OPL being defined with respect to a position of the encoder scale.

The interferometry system can include a photodetector and an electronic processor, the electronic processor being configured to derive heterodyne phase information from a signal detected by the photodetector during operation of the interferometry system. The second cavity can include a diffractive encoder scale, and the electronic processor can be configured to obtain position information about a degree of freedom of the encoder scale based on the heterodyne phase information during operation of the interferometry system.

Certain implementations may have particular advantages. For example, in some implementations, the interferometry system can aid in the rejection of unwanted ghost beams through the use of low coherent illumination and a coupled-cavity architecture. One of the coupled cavities (the heterodyne cavity) can encode a heterodyne modulation and define a system optical path difference (OPD), whereas the other cavity (the test cavity) can include a read-head interferometer. This combination can be particularly useful for encoder interferometry systems in which the range of motion of the encoder interferometry system perpendicular to an encoder scale plane is limited. By selecting the coherence of an illumination source to encompass that range, ghost beams whose optical paths exceed that range do not coherently interfere with the test beam and can therefore be rejected electronically. In addition, the read-head interferometer can include various different optical geometries, so long as the cavity OPD restrictions are met. Moreover, the heterodyne cavity does not need to be positioned directly adjacent to the test cavity. Rather, the heterodyne cavity can be located at positions which are remote from the test cavity. The heterodyne cavity can be a source of excessive heat, which may adversely affect the optical path length of the test cavity (e.g., by inducing a change in refractive index of optical components within the test cavity), and thus introduce error into position calculations. By placing the heterodyne cavity at a location remote from the test cavity, errors due to excessive heat from the modulator cavity can, in some implementations, be avoided.

The details of one or more embodiments are set forth in the accompanying drawings and the description below. Other features and advantages will be apparent from the description, the drawings, and the claims.

### BRIEF DESCRIPTION OF DRAWINGS

FIG. 1 is a schematic of an example of an interferometric optical encoder system.

FIG. 2 is a schematic of an example of an encoder read-head.

FIG. 3 is a schematic of example of a beam path for an optical interferometry system.

FIG. 4 is a schematic of an example of an interferometric optical encoder system.

FIG. 5 is a schematic of an example of a test cavity.

FIG. 6 is a schematic of an example of an encoder read-head.

FIG. 7 is a schematic showing an example of a portion of an interferometer modified to operate with a low coherence source and a heterodyne cavity.

FIG. 8A is a block diagram of a portion of an interferometer modified to operate with a low coherence source and a heterodyne cavity.

FIG. 8B is a schematic showing an example of a portion of an interferometer modified to operate with a low coherence source and a heterodyne cavity.

FIG. 9 is a schematic showing an example of a portion of an interferometer modified to operate with a low coherence source and a heterodyne cavity.

FIG. 10 is a schematic showing an example of a portion of a multiple channel distance measuring interferometer modified to operate with a low coherence source and a heterodyne cavity.

FIG. 11 is a schematic diagram of an embodiment of a lithography tool that includes an interferometer.

FIG. 12A and FIG. 12B are flow charts that describe procedures for making integrated circuits.

### DETAILED DESCRIPTION

The present disclosure is directed toward low coherence interferometry using encoder systems. The disclosure below is organized into three sections. A first section of the disclosure, entitled “Interferometric Optical Encoder Systems,” relates to a general description of how an interferometric optical encoder system can operate. A second section of the disclosure, entitled “Low Coherence Optical Encoder Systems,” relates to example optical encoder systems and their operation based on low coherence illumination and coupled-cavity architectures. A third section of the disclosure, entitled “Lithography Tool Applications,” relates to incorporating optical encoder systems in lithography systems.

Interferometric Optical Encoder Systems

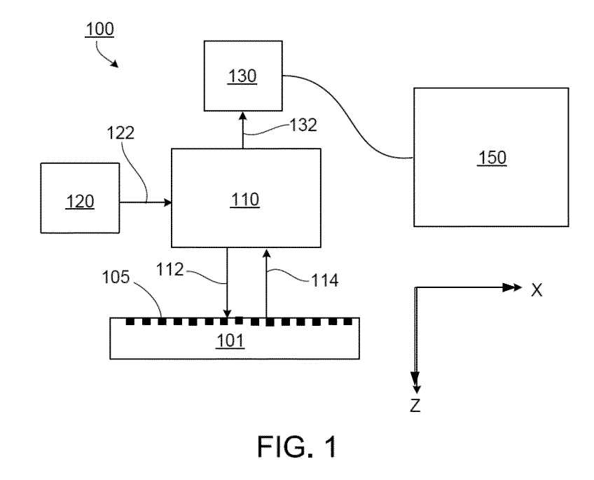

Referring to FIG. 1, an interferometric optical encoder system 100 includes a light source module 120 (e.g., including a laser), an optical assembly 110, a measurement object 101, a detector module 130 (e.g., including a polarizer and a detector), and an electronic processor 150. Generally, light source module 120 includes a light source and can also include other components such as beam shaping optics (e.g., light collimating optics), light guiding components (e.g., fiber optic waveguides) and/or polarization management optics (e.g., polarizers and/or wave plates). Various embodiments of optical assembly 110 are described below. The optical assembly is also referred to as the “encoder head.” A Cartesian coordinate system is shown for reference. In the example of FIG. 1, the Y-axis extends along a direction normal to the page.

Measurement object 101 is positioned some nominal distance from optical assembly 110 along the Z-axis. In many applications, such as where the encoder system is used to monitor the position of a wafer stage or reticle stage in a lithography tool, measurement object 101 is moved relative to the optical assembly in the X- and/or Y-directions while remaining nominally a constant distance from the optical assembly relative to the Z-axis. This constant distance can be relatively small (e.g., a few centimeters or less). However, in such applications, the location of measurement object typically will vary a small amount from the nominally constant distance and the relative orientation of the measurement object within the Cartesian coordinate system can vary by small amounts too. During operation, encoder system 100 monitors one or more of these degrees of freedom of measurement object 101 with respect to optical assembly 110, including a position of measurement object 101 with respect to the X-axis, and further including, in certain embodiments, a position of the measurement object 101 with respect to the Y-axis and/or Z-axis and/or with respect to pitch and yaw angular orientations.

To monitor the position of measurement object 101, source module 120 directs an input beam 122 to optical assembly 110. Optical assembly 110 derives a measurement beam 112 from input beam 122 and directs measurement beam 112 to measurement object 101. Optical assembly 110 also derives a reference beam (not shown) from input beam 122 and directs the reference beam along a path different from the measurement beam. For example, optical assembly 110 can include a beam-splitter that splits input beam 122 into measurement beam 112 and the reference beam. The measurement and reference beams can have orthogonal polarizations (e.g., orthogonal linear polarizations).

Measurement object 101 includes an encoder scale 105, which is a measuring graduation that diffracts the measurement beam from the encoder head into one or more diffracted orders. In general, encoder scales can include a variety of different diffractive structures such as gratings or holographic diffractive structures. Examples or gratings include sinusoidal, rectangular, or saw-tooth gratings. Gratings can be characterized by a periodic structure having a constant pitch, but also by more complex periodic structures (e.g., chirped gratings). In general, the encoder scale can diffract the measurement beam into more than one plane. For example, the encoder scale can be a two-dimensional grating that diffracts the measurement beam into diffracted orders in the X-Z and Y-Z planes. The encoder scale extends in the X-Y plane over distances that correspond to the range of the motion of measurement object 110.

In the present embodiment, encoder scale 105 is a grating having grating lines that extend orthogonal to the plane of the page, parallel to the Y-axis of the Cartesian coordinate system shown in FIG. 1. The grating lines are periodic along the X-axis. Encoder scale 105 has a grating plane corresponding to the X-Y plane and the encoder scale diffracts measurement beam 112 into one or more diffracted orders in the Y-Z plane. While encoder scale 105 is depicted in FIG. 1 as a structure that is periodic in one direction, more generally, the measurement object can include a variety of different diffractive structures that appropriately diffract the measurement beam.

At least one of these diffracted orders of the measurement beam (labeled beam 114), returns to optical assembly 110, where it is combined with the reference beam to form an output beam 132. For example, the once-diffracted measurement beam 114 can be the first-order diffracted beam.

Output beam 132 includes phase information related to the optical path length difference between the measurement beam and the reference beam. Optical assembly 110 directs output beam 132 to detector module 130 that detects the output beam and sends a signal to electronic processor 150 in response to the detected output beam. Electronic processor 150 receives and analyzes the signal and determines information about one or more degrees of freedom of measurement object 101 relative to optical assembly 110.

In certain embodiments, the measurement and reference beams have a small difference in frequency (e.g., a difference in the kHz to MHz range) to produce an interferometry signal of interest at a frequency generally corresponding to this frequency difference. This frequency is hereinafter referred to interchangeably as the “heterodyne” frequency or the “reference” frequency. Information about the changes in the relative position of the measurement object generally corresponds to a phase of the interferometry signal at this heterodyne frequency. Signal processing techniques can be used to extract this phase and thus determine the relative change in distance. Examples of exemplary techniques for extracting the phase and further discussion of interferometric optical encoder systems and operation can be found in U.S. Pat. No. 8,300,233, the contents of which are incorporated herein by reference in their entirety.

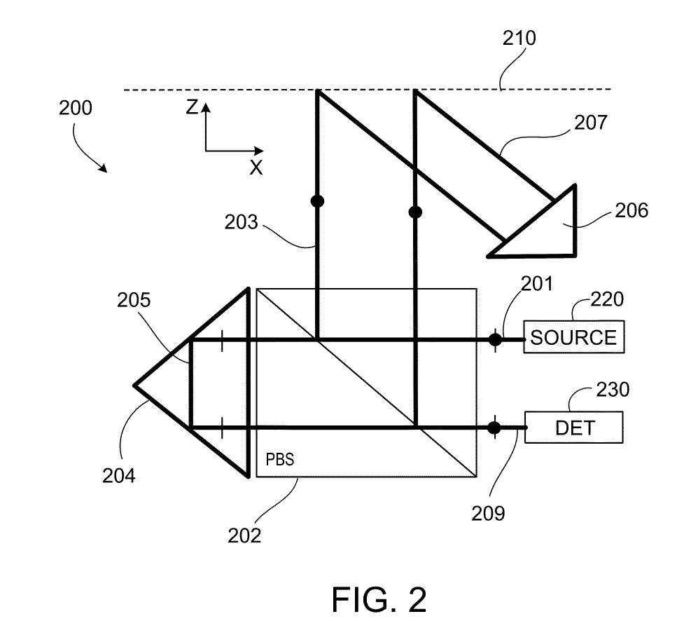

FIG. 2 is a schematic of an example encoder read-head 200 that can be used in interferometric optical encoder systems. The encoder read-head 200 includes a beam-splitter 202, a reference retro-reflector 204 (e.g., a cube-corner reflector), and a measurement retro-reflector 206 (e.g., a cube-corner reflector). In other implementations, the encoder read-head 200 can include additional optical components such as optical filters, lenses or further beam-splitters and/or retro-reflectors. An illumination source 220 directs an input beam 201 towards the beam-splitter 202. The beam-splitter 202 then derives a measurement beam 203 and a reference beam 205 from input beam 201, where the measurement beam 203 is directed towards a target object 210 (e.g., an encoder scale), diffracted, re-directed by retro-reflector 206 toward the target object 210, where the beam is diffracted again. The reference beam 205 propagates towards the reference retro-reflector 204 where the beam 205 is redirected back to the beam-splitter 202. The twice-diffracted measurement beam 207 also returns to the beam-splitter 202, where the diffracted beam 207 is combined with the retro-reflected reference beam 205 to form an output beam 209 that is passed to detector 230.

In some implementations, however, the separation of the measurement beam and the reference beam components from the input beam 201 may be imperfect, e.g., a portion of the measurement beam component does not follow the measurement beam path and/or a portion of the reference beam component does not follow the reference beam path, leading to inadvertent beam “mixing.” Similarly, portions of the retro-reflected beam and the diffracted measurement beam may follow other unintended pathways leading to additional accidental beam mixing.

In general, the spurious beams that mix with other beams traveling along preferred pathways are called “ghost beams.” The ghost beams may have different amplitudes, different phase offsets, and/or different frequencies from the beams with which they combine, resulting in a shift in a detected interference signal frequency or phase, or a change in detected interference signal amplitude, each of which can lead to errors in measurements of the position of the encoder scale.

Low Coherence Optical Encoder Systems

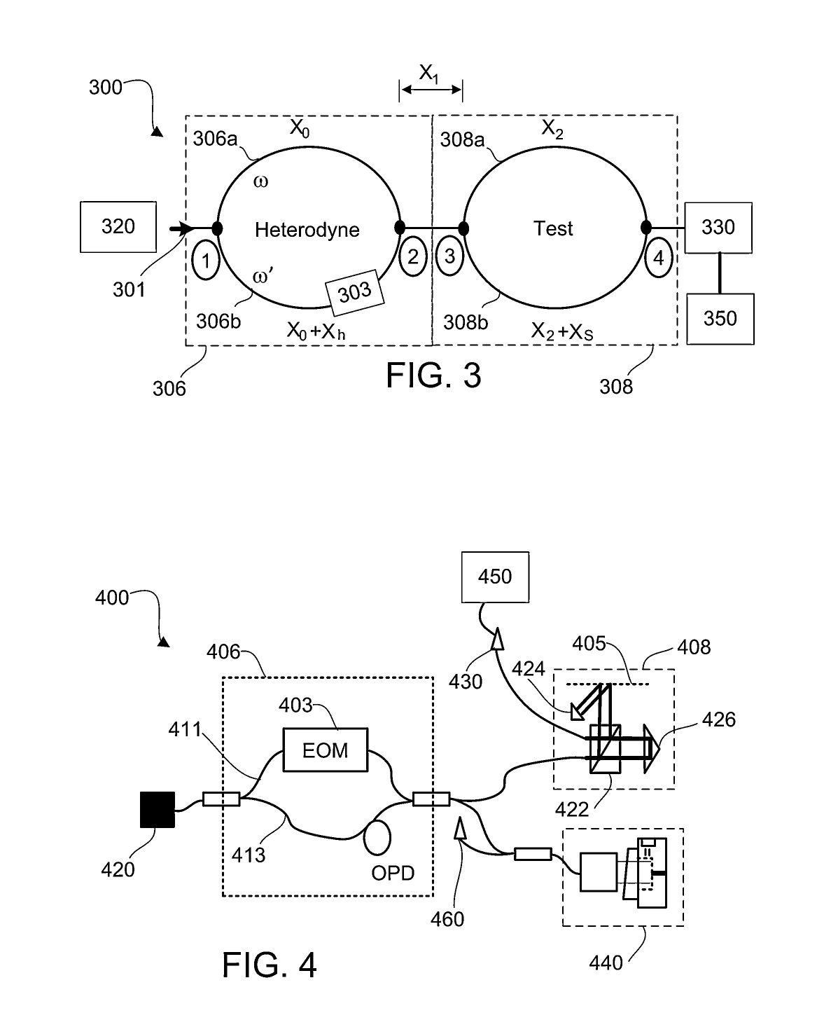

FIG. 3 is a schematic of example beam path for an optical interferometry system 300 that can reduce or eliminate measurement errors associated with the presence of ghost beams. In particular, the system 300 is configured to establish a defined coherence range, in which ghost beams having optical paths outside the defined range do not coherently interfere with the measurement beam and, as a result, can be electronically rejected by the system 300.

The system 300 includes a low coherence illumination source 320 that provides an input beam 301 to a coupled-cavity module. The coupled-cavity module includes a first interferometer cavity 306 (the “heterodyne” or “modulator” cavity) coupled in series with a second interferometer cavity 308 (the “test” cavity). The output from the coupled-cavity module is provided to a detector 330, which in turn is coupled to an electronic processor 350. Different positions along the system are denoted by nodes (1), (2), (3) and (4). The first interferometer cavity 306 includes nodes (1) and (2). The second interferometer cavity 308 includes nodes (3) and (4).

The low coherence source 320 can include any suitable light source that is capable of producing a beam having low coherence. For the purpose of this disclosure, a low coherence beam is a beam that has a broad spectral width (e.g., spectrally broader than a laser) or low temporal coherence such as, for example, a light emitting diode (LED) or a halogen lamp.

The temporal coherence for a Gaussian spectral shape can be expressed by the following contrast function

$$C ( d , λ , σ ) = exp [ - 2 π ln ( 2.2 ) {( \frac{4 σ d}{{λ}^{2}} )}^{2} ]$$

Where C( ) is the (normalized) contrast, d is the optical delay, σ is the Gaussian 1/e width, and λ is the spectrum mean wavelength. So given λ and σ, one can calculate the contrast observed as a function of delay (optical path difference). For example, if λ=1550 nm and σ=0.5 nm, then the contrast at full-width at half-maximum (FWHM) is about 1.1 mm (double pass).

The heterodyne cavity 306 includes an unequal-path cavity, in which the input beam 301 is split into two distinct beams (first leg 306a and second leg 306b) that travel down separate paths having different lengths. The difference in length between the two paths of the cavity 306 defines an optical path difference (OPD) between the two beams. For example, in some implementations, the length of the first leg 306a of the heterodyne cavity 306 shown in FIG. 3 is longer than the second leg 306b of the heterodyne cavity 306, or vice versa. One or both legs of the cavity 306 also can include a frequency shifting device 303, which imparts a known optical frequency difference (the heterodyne frequency) or a known rate of phase change to the beams.

The test cavity 308 also includes an unequal-path cavity, in which an OPD of the second cavity 308 is nominally the same as the OPD of the first cavity 306. That is, the OPD of the second cavity 308 is approximately equal to the OPD of the first cavity 306. Typically, the OPD of the first cavity (the heterodyne cavity) is fixed, whereas the second cavity (the test cavity) OPD will change due to movement of the test surface. Accordingly, the OPD of the second cavity should be set with a precision that guarantees sufficient contrast over the full range of the test surface motion. Similar to the heterodyne cavity 306, the test cavity 308 is configured to split an input beam into distinct beams that follow separate paths (measurement path 308a and reference path 308b). The length of one path of the test cavity 308 can be defined based on the relative position of a test object to the interferometer system (e.g., a measurement path 308a) whereas the length of the other path (reference path 308b) of cavity 308 is the reference path length. In certain implementations, light emanating from the coupled-cavity arrangement interferes at the heterodyne frequency and the phase of the interfering signal is modulated proportional to the difference between the OPD of the heterodyne cavity 306 and the test cavity 308. Electronic demodulation of the heterodyne carrier then can be used to extract the underlying phase change, and hence the change in OPDs between the two cavities. Thus, if the OPD variation of the heterodyne cavity 306 is known, it is possible to determine the OPD variation of the test cavity 308, and the corresponding change in position of the encoder scale. Moreover, ghost beams having optical path lengths that are outside of the coherence length of the source illumination can be rejected. The order in which the cavities are arranged can be arbitrary. That is, the test cavity can be arranged preceding the heterodyne cavity or following the heterodyne cavity.

During operation of the system 300, low coherence light from the illumination source 320 enters the heterodyne cavity at node (1). As explained above, the input beam 301 is split into two distinct beams that follow separate paths having different path lengths x. The first path 306a in the heterodyne cavity 306 has a path length x₀ whereas the second path 306b in the heterodyne cavity 306 has a predetermined OPD of xₕ so that the overall path length in the second path is x₀+xₕ. In the present example, the second path 306b of the heterodyne cavity also includes a frequency shifting device 303 (e.g., an acousto-optical modulator formed of quartz or TeO₂ or an electro-optic modulator) that imparts an optical frequency difference between the light traveling in the two legs of the cavity 306. Thus, the output of the heterodyne cavity 306 at node (2) includes light having a frequency ω and light shifted to a second different frequency ω′ with ω′=ω+ωₕ, where ωₕ is the heterodyne frequency.

The light from heterodyne cavity 306 then proceeds a distance x₁ prior to entering the test cavity 308 at node (3), where x₁ is the distance between the two cavities. The first path 308a in test cavity 308 has an optical path length of x₂, whereas the second path 308b in the test cavity 308 has an optical path length of x₂+xₛ, where xₛ, is the adjustable OPD of the test cavity. For example, in some implementations, x₂+xₛ corresponds to the length light travels along a reference path in the test cavity 308, in which xₛ can be adjusted by modifying the position of a retro-reflector on which the light is incident.

In the example arrangement of FIG. 3, the path lengths of each leg in the two cavities are configured so that the test cavity OPD is approximately equal to the heterodyne cavity OPD within the coherence length (CL) of the source illumination. In other words, the difference between the OPD of the two cavities is given by |xₕ−xₛ|<CL. Assuming that xₕ and xₛ also are much greater than the coherence length, the electric fields at the nodes indicated in FIG. 3 are proportional to (ignoring normalization):

$$\begin{matrix}{e}^{i ω t} & ( 1 ) \\ {e}^{i ω t} {e}^{- i {kx}_{0}} + {e}^{i {ω}^{‵} t} {e}^{- i {k}^{‵} ( {x}_{0} + {x}_{h} )} where k = ω / c and {k}^{‵} = {ω}^{‵} / c & ( 2 ) \\ {e}^{i ω t} {e}^{- i k ( {x}_{0} + {x}_{1} )} + {e}^{i {ω}^{‵} t} {e}^{i {k}^{‵} ( {x}_{0} + {x}_{1} + {x}_{h} )} & ( 3 ) \\ {e}^{i ω t} {e}^{- i k ( {x}_{0} + {x}_{1} + {x}_{2} )} + {e}^{i ω {t}_{{e}^{- i k ( {x}_{0} + {x}_{1} + {x}_{2} + {x}_{s} )}}} + {e}^{i {ω}^{‵} t} {e}^{- i {k}^{‵} ( {x}_{0} + {x}_{1} + {x}_{2} + {x}_{h} )} + {e}^{i {ω}^{‵} t} {e}^{- i {k}^{‵} ( {x}_{0} + {x}_{1} + {x}_{2} + {x}_{h} + {x}_{s} )} = {e}^{i ω t} {e}^{i k ( \sum x )} + {e}^{i ω t} {e}^{- i k ( \sum x + {x}_{s} )} + {e}^{i {ω}^{‵} t} {e}^{- i {k}^{‵} ( \sum x + {x}_{h} )} + {e}^{i {ω}^{‵} t} {e}^{- i {k}^{‵} ( \sum x + {x}_{h} + {x}_{s} )} where \sum x = {\sum }_{j = 0}^{2} {x}_{j} & ( 4 )\end{matrix}$$

At node (4), the detector 330 records the squared modulus of the electric field. An expression for the squared modulus can be obtained by assigning the unknown terms A, B, C, and D to the four exponential terms of the field, respectively, at node (4). The squared modulus then results in 16 unknown terms, which can be expressed as AA*+AB*+AC*+AD*+BA*+BB*+BC*+BD*+CA*+CB*+CC*+CD*+DA*+DB*+DC*+DD*. Four of the resulting unknown constants include “self-interference” terms (i.e., AA*, BB*, CC* and DD*). The self-interference terms correspond to constant (i.e., zero frequency) background signals and thus do not contribute to the interference signal. Similarly, the unknown constants AB*, BA*, CD*, DC* also are associated with constant background signals and can be ignored.

The unknown terms AC*, CA*, BD* and DB* are associated with signals having the correct heterodyne frequency (k-k′) but an optical path length (OPL) equal to |xₕ|. As noted above, xₕ is much larger than the CL of the source illumination. Accordingly, such signals also contribute as part of a constant background and can be ignored.

Similarly, the terms AD* and DA* are associated with signals having the correct heterodyne frequency and an optical path length of |xₕ+xₛ|. Given that both xₕ and xₛ are outside the CL, the corresponding signals also contribute to background and can be ignored.

However, the terms BC* and CB* have the correct heterodyne signal frequency and an optical path length equal to |xₕ−xₛ|, which is very close to zero and within the CL of the source illumination. Accordingly, the signals associated with BC* and CB* are the signals of interest. The sum of the unknown constants BC* and CB* can be expressed as:

$${BC}^{*} + {CB}^{*} = cos ( - {ω}_{h} t + \frac{{ω}_{h}}{c} \sum x - \frac{ω {x}_{s} - ω {x}_{h}}{c} + \frac{{ω}_{h} {x}_{h}}{c} )$$

where ωₕ=ω−ω′ and k=ω/c, with c being the speed of light. The argument of the last term can be ignored as a negligible constant (e.g., of order 30 microrad for ωₕ≈1 MHz and xₕ≈10 mm), such that

$${BC}^{*} + {CB}^{*} ≅ cos ( - {ω}_{h} t + \frac{{ω}_{h}}{c} \sum x - ω \frac{{x}_{s} - {x}_{h}}{c} ) .$$

The first term in the foregoing equation is the carrier term. The second, middle term is a small constant phase contribution from the overall fixed path length. Increasing the distance between the two cavities (x₁) changes the phase of the second term, but only very slowly since it is proportional to the heterodyne frequency rather than the optical frequency of the illumination source. The separation distance x₁ between the heterodyne cavity and the test cavity can be very large, allowing the heterodyne cavity to be remote from the test cavity. The last term in the foregoing equation is the phase of interest and is proportional to the difference in OPDs (i.e., xₛ−xₕ) between the test cavity and the heterodyne cavity. To obtain the phase of the test cavity alone, the heterodyne cavity can be configured to have a constant or fixed OPD such that the variation in phase is due to the change in path length of one leg of the test cavity alone. Alternatively, the heterodyne cavity can be monitored by coupling it with another cavity of fixed OPD.

The frequency shifting device 303 can produce the heterodyne frequency difference in the two legs of the 1^{st} cavity in various ways. For example, the frequency shifting device 303 can include an acousto-optical modulator (AOM) device that is inserted into one or both legs of the heterodyne cavity, in which the modulator in each leg is driven by a different frequency. The difference between the two frequencies (or between a frequency of a single modulator in one leg and the frequency of illumination in the other leg) corresponds to the heterodyne frequency. In another example, the frequency shifting device 303 can include an electro-optic phase modulator (EOM) that is incorporated into a first leg of the heterodyne cavity and driven with a waveform (e.g., a sawtooth waveform) having an amplitude that produces a 2π phase shift. The frequency of the waveform corresponds to the heterodyne frequency. The foregoing approach is generally referred to as the Serrodyne method. Alternatively, in some implementations, two phase modulators are used, with one phase modulator in each leg of the heterodyne cavity, in which the modulators are driven simultaneously in a Serrodyne fashion with amplitude of π but with opposite phase to produce the same result. In some implementations, using the Serrodyne method produces a constant heterodyne frequency such that a simple Fourier Transform can be applied to the detected interference signal to recover the phase.

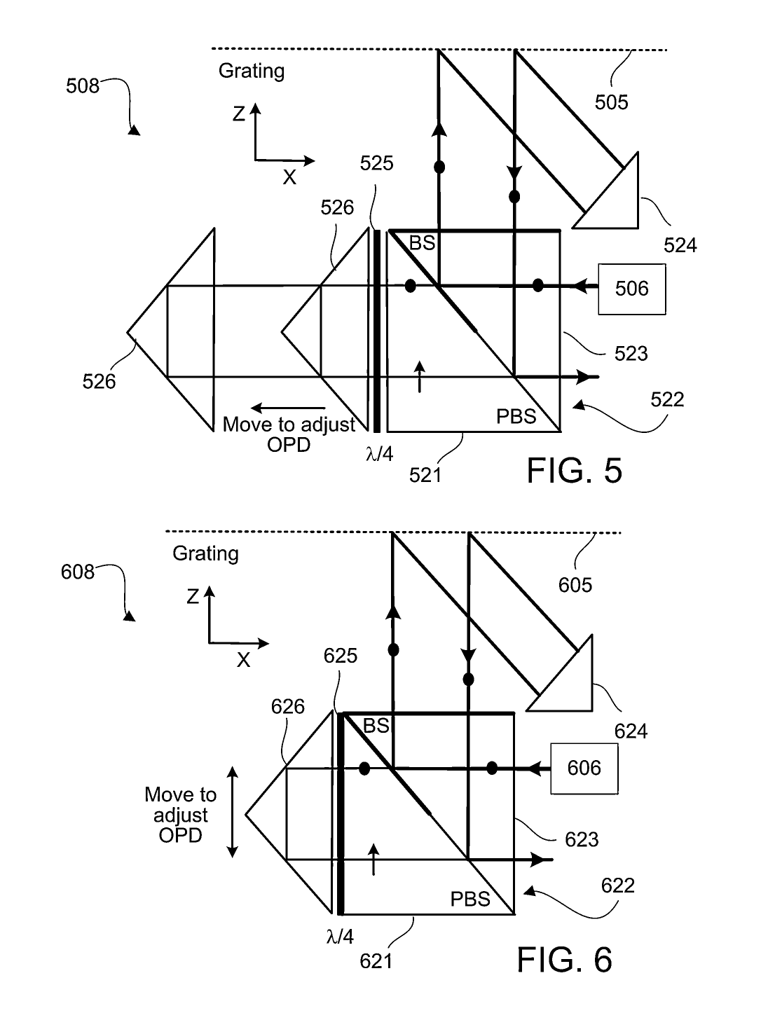

Various embodiments of the interferometer system 300 can be employed. For instance, FIG. 4 is a schematic of an example encoder system 400 that uses an encoder read-head as a test cavity 408. The input to the test cavity 408 is provided by a heterodyne cavity 406 that is composed of two separate optical paths having different lengths of optical fiber. In an example, the heterodyne cavity 406 guides light from a low coherence illumination source 420 using polarization-maintaining (PM) fibers. Alternatively, or in addition, the light in the legs of cavity 406 can be guided in free space using optical components, such as lenses and mirrors. A first leg 411 of the heterodyne cavity 406 has an additional length relative to the second leg 413 to set the cavity OPD. In addition, an electro-optical modulator 403 is incorporated into the first leg 411 as a frequency shifting device. Using the Serrodyne method described above, the modulator 403 causes a shift in the frequency of the light output by the heterodyne cavity 406 from that leg by a heterodyne frequency fₕ. The coherence length of the source 420 is tailored based on the range of expected motion perpendicular to the grating plane. To minimize signal (interference) loss, the coherence length must be longer than the expected motion perpendicular to the grating plane. The output of the heterodyne cavity 406 then is sent to the test cavity 408.

The test cavity 408 includes a beam splitter 422, a measurement retro-reflector 424, and a reference retro-reflector 426 (e.g., cube corner reflectors). In some implementations, the retro-reflectors and/or beam splitter 422 can be fixed to adjustable mounts, which allow movement of the retro-reflectors and/or beam-splitter in one or more directions. The beam-splitter 422 splits input light into a measurement path and a reference path. Light traveling along the measurement path is diffracted by an encoder scale 405 and returns to the beam-splitter 422, where the diffracted light combines with reference light that has been reflected by reference retro-reflector 426. The combined light then is sent to a photodetector 430. A processor 450 analyzes the signal received by photodetector 430 to determine phase information.

The OPD of the test cavity 408 corresponds to the difference in optical path length between the measurement and reference paths of the encoder read head. Interference occurs at photodetector 430 if the difference in OPD's between the heterodyne cavity 406 and the test cavity 408 is less than the source coherence length. The phase obtained from the photodetector 430 is proportional to the difference in OPDs between the heterodyne and encoder cavities. To obtain the phase of the test cavity 408 alone, one can subtract the phase corresponding to the OPD of the heterodyne cavity 406. One technique for obtaining the phase of the test cavity 408 includes subtracting the phase from a fixed OPD cavity, whose OPD is restricted to be the substantially the same as the heterodyne cavity OPD within the illumination coherence length, and ideally equal to the heterodyne cavity OPD. For example, FIG. 4 shows a fixed interferometer cavity 440 configured to have the same OPD as the heterodyne cavity 406. The fixed interferometer cavity 440 splits light incident to the cavity 440 into two paths that have a specified OPD before recombining the light from the two paths. Photodetector 460 receives an output signal from fixed interferometer cavity 440. Processor 450 is coupled to detector 460. For ease of viewing, the coupling of processor to photodetector 460 is not shown. The processor 450 extracts the phase information from a signal received by photodetector 460 and subtracts this phase from the phase information obtained from photodetector 430 to obtain the phase, and thus test object displacement information, of the test cavity 408 alone. It is noted that for each interferometer in the system 400, the OPD should be much greater than the source coherence length to minimize errors that can occur due to the presence of ghost beams.

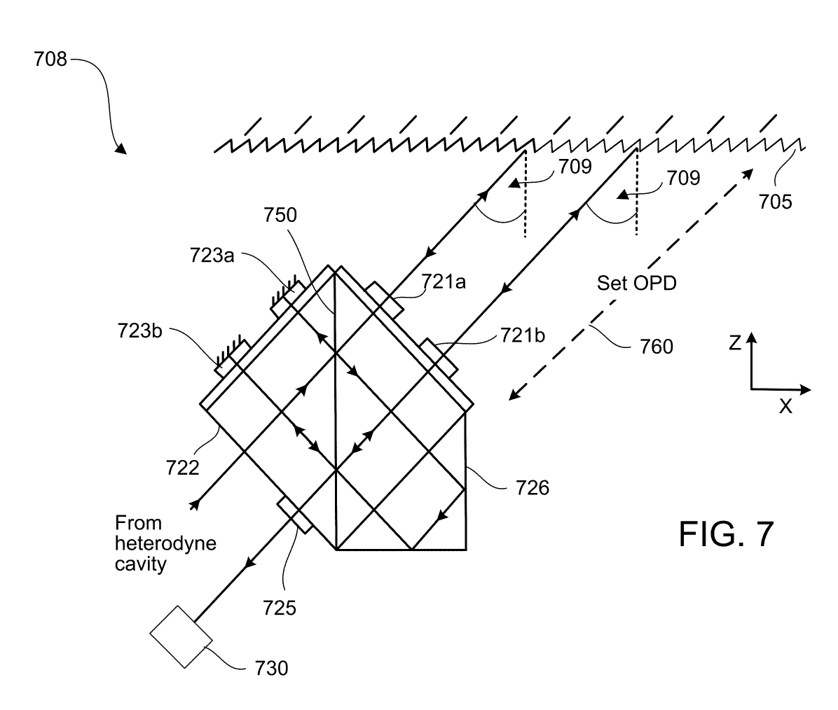

In some embodiments, the encoder read-head can be configured such that the test cavity OPD is adjustable. For example, FIG. 5 is a schematic example of a test cavity 508 of an encoder system in which the test cavity includes an adjustable encoder read head. In particular, the encoder read head includes a measurement retro-reflector 524 (e.g., a cube corner reflector), a ¼ wave plate 525, a beam-splitter 522, and an adjustable reference retro-reflector 526 (e.g., a cube corner reflector attached to an adjustable mount). The beam-splitter 522 is composed of a non-polarizing beam-splitter portion 523 and a polarizing beam-splitter portion 521.

During operation of the encoder system, light with the appropriate polarization (e.g., S-polarized light) is provided from a heterodyne cavity 506 and strikes the non-polarizing beam-splitter portion 521 of the main beam-splitter cube 522. In some implementations, the heterodyne cavity 506 is positioned after the test cavity but before the encoder scale 505. Assuming the encoder scale 505 has reflection coefficient R_{G} into the diffraction order of interest, the beam-splitter should be configured to reflect approximately 1/(1+R_{G}²) of the input beam into a test beam that is redirected toward the encoder scale 505 and transmit the remaining portion of the input beam to a reference beam to balance the reference and test intensities.

The reference beam passes through the ¼-wave plate 525, to the adjustable reference retro-reflector 526, again through the ¼-wave plate 525 to change the polarization (e.g., from S-polarized light to P-polarized light), through the polarizing beam-splitter portion 521 of the main beam-splitter cube 522 and combines with the test beam. The position of the reference retro-reflector 526 can be adjusted in the present example along the X-direction in order to set the test cavity OPD to nominally the same as the OPD of the heterodyne cavity 506. Alternatively, in some implementations, the reference retro-reflector 526 can be fixed to the beam-splitter cube 522 and the distance of the beam-splitter cube 522 relative to the encoder scale 505 can be adjusted.

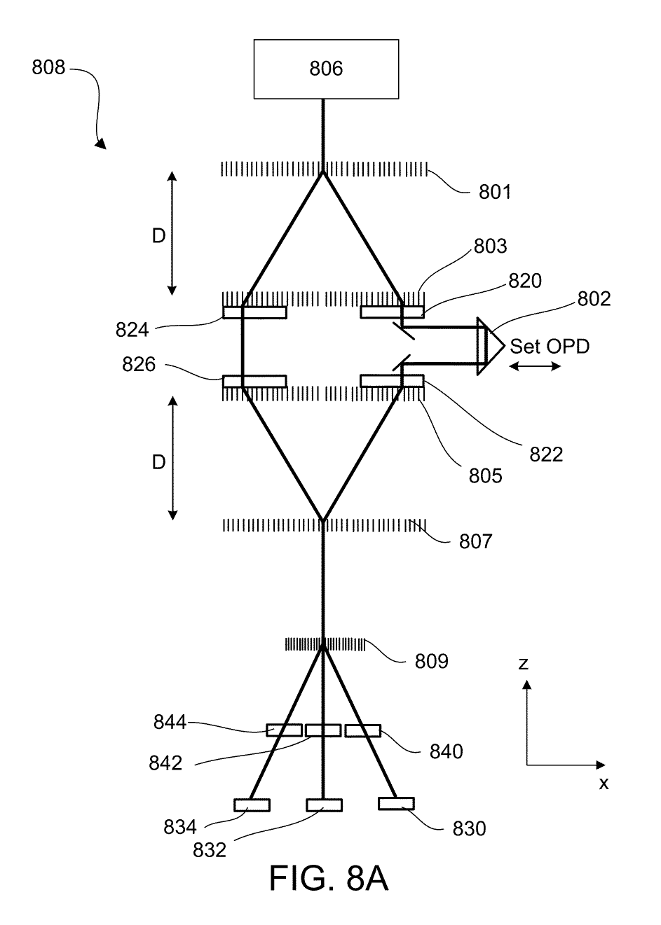

FIG. 6 is a schematic of an example encoder read-head in which the reference retro-reflector 626 is fixed to an adjustable beam-splitter cube portion 622 through a ¼-wave plate 625, where the cube 622 is similar in construction to the beam-splitter cube 522 shown in FIG. 5. In the example of FIG. 6, the position of the cube 622 itself can be adjusted along the Z-direction (e.g., by fixing the cube 622 to an adjustable mount) to set the OPD of the test cavity to nominally the same as the OPD of a heterodyne cavity 606. In some implementations, a combination of the encoder read-head arrangements shown in FIGS. 5 and 6 can be used, in which both the reference retro-reflector and the beam-splitting cube are configured to have an adjustable position (e.g., using one or more actuators, such as an electromechanical actuators).

Various encoder system geometries can be modified to employ the same general configuration as shown in FIG. 3. For example, in some embodiments, the configuration shown in FIG. 3 can be achieved by 1) replacing an encoder system illumination source with a low coherence illumination source and a heterodyne cavity, 2) coupling the output of the heterodyne cavity to the preexisting test cavity, and 3) ensuring that the OPDs of the two cavities satisfy the restrictions that enable rejection of unwanted ghost beams (e.g., |xₕ−xₛ|<CL and OPDs much greater than CL). In some embodiments, the OPD requirements can be satisfied without any substantial changes to the arrangement of the test cavity. Rather, the test cavity is modified just to set the optical path length of the test path and restrict the range of allowed variations in that path.

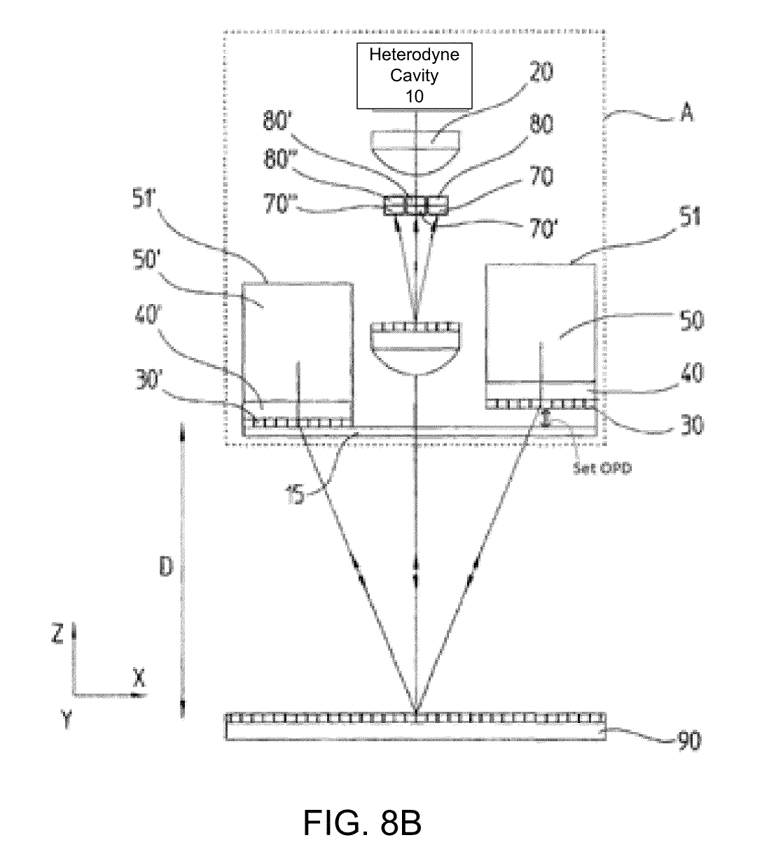

FIG. 7 is a schematic showing a cross-section of an example of an encoder head that has been modified to operate as a test cavity geometry in conjunction with a low coherence source and a heterodyne cavity (such as, for example, the heterodyne cavity shown in FIG. 4). A description of the design and operation of the interferometer system that included the encoder head prior to modification can be found in U.S. Pat. No. 7,440,113, the contents of which are incorporated herein by reference in their entirety.

As shown in FIG. 7, the test cavity 708 includes a retro-reflector 726 (e.g., a cube corner reflector), a beam-splitter 722, first and second polarization changing elements 721a, 721b, third and fourth polarization changing elements 723a, 723b, and a mixing polarizer 725 (e.g., sheet polarizers or cube polarizers). Examples of polarization changing elements include, but are not limited to, wave plates such as ¼ wave plates and ½ wave plates. The third and fourth polarization changing elements 723a and 723b may include a reflective coating (e.g., reflective dielectric thin-film stacks or mirror coatings including metals, such as aluminum, silver, or gold) to reflect incident light back towards the beam-splitter 722.

Light composed of two orthogonally polarized components is provided from a heterodyne cavity. At an interface 750 of the beam-splitter 722, the input light from the heterodyne cavity is split into a measurement beam and a reference beam based on differences in polarization of the components of the input beam. For example, the measurement beam may have a first polarization type (e.g., p-polarized), in which the measurement beam traverses the beam splitter interface and the first polarization changing element 721a so as to be incident on encoder scale 705 at a Littrow angle 709 (i.e., where the angle of incidence is equal to the angle of reflection). The diffraction of the emerging measurement beam traverses the first polarization changing device 721a causing the beam to have the second polarization type (e.g., s-polarized). The diffracted measurement beam reflects at the beam splitter interface 750, travels through the retro-reflector 726, reflects again at the beam splitter interface 750, and traverses the second polarization changing element 721b. A second pass emerging measurement beam is incident at the encoder scale 705 at the Littrow angle 709. A diffraction of the second pass emerging measurement beam is co-linear with the incident beam and traverses the second polarization changing device 721b again to become a second pass measurement beam having the first polarization type (e.g., p-polarization). The p-polarized second pass measurement beam traverses the beam splitter interface 750 and the mixing polarizer 725 to the detector 730.

The reference beam formed at the interface 750 of the beam-splitter may have a second polarization (e.g., s-polarization) different to that of the measurement beam derived at interface 750 from the input beam. The reference beam then reflects from third polarization changing device 723a, propagates back through interface 750 toward retro-reflector 726, where the reference beam is redirected back again through interface 750. After passing through interface 750 a second time, the reference beam reflects from fourth polarization changing device 723b and then reflects from the beam-splitter interface 750 toward detector 730. Prior to reaching detector 730, the reference beam passes through the mixing polarizer 725 to combine with the measurement beam.

In the example shown in FIG. 7, the test path optical path length (and thus the cavity OPD) can be modified by adjusting the distance along which the first pass and second pass measurement beams travel from the beam-splitter 722 to the encoder scale 705. For example, the configuration including the beam-splitter 722, retro-reflector 726 and polarization changing elements can be translated along a path 760 towards or away from the encoder scale 705, in which the path intersects the encoder scale 705 at the Littrow angle. Alternatively, or in addition, the reference path optical path length can be modified, for example, by adjusting a position of the retro-reflector 726 relative to the beam-splitter 722.

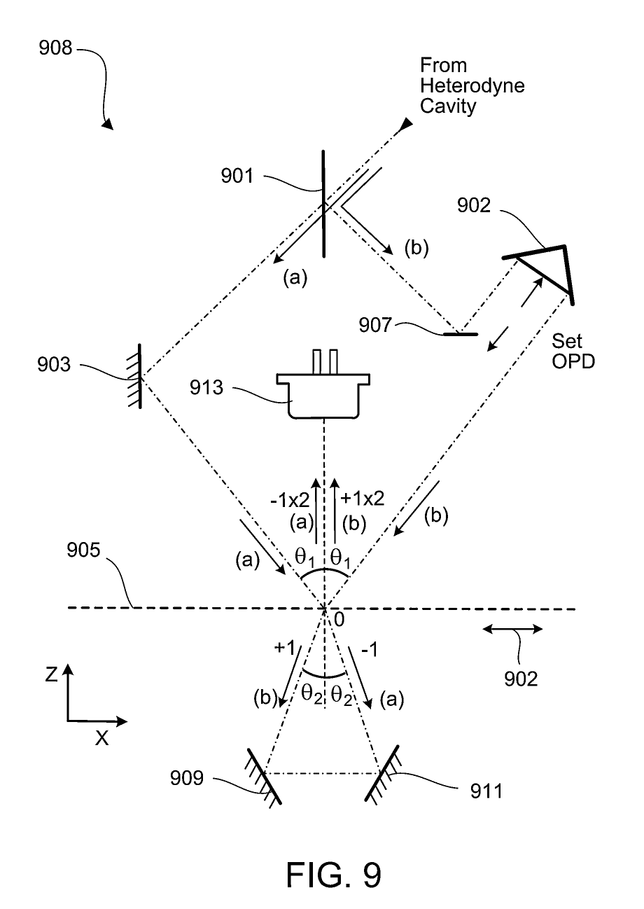

FIG. 8A is a block diagram of another example of an encoder head of a position measuring device that has been modified to operate as a test cavity in conjunction with a low coherence source and a heterodyne cavity. FIG. 8B is a front view of an embodiment of a four-grating interferometer, based on the beam path shown in FIG. 1. A description of the design and operation of the four-grating interferometer system that included the encoder head prior to modification can be found in U.S. Pat. No. 7,019,842, the contents of which are incorporated herein by reference in their entirety. The position measuring device includes a scale and a scanning unit that is displaced with respect to the scale in a measuring direction. The scanning unit includes a scanning grating, a ridge prism and an optoelectronic detector element. The ridge prism having a ridge that is oriented parallel with the measuring direction, the ridge prism acts as a retro-reflector in a second direction which is aligned in a plane of the scale vertically with respect to the measuring direction. The beam path shown in FIG. 8A is displayed for an unfolded representation.

The test cavity 808 includes a grating interferometer to measure the motion between gratings. In this interferometer the measurement direction is the X-direction. As in the previous examples, the Y-axis extends along a direction normal to the page surface.

For example, the grating interferometer of test cavity 808 is a four-grating (801, 803, 805, 807) transmission grating, in which the gratings have the same grating constant or graduation period. The “test” or “measurement” object includes gratings 801 and 807. Thus, the motion of gratings 801, 8007 is what is being detected in this implementation. The scale grating 801 is vertically illuminated by light incident from a heterodyne cavity 806 (e.g., the heterodyne cavity shown in FIG. 4). In the present example, the graduation period of grating 801 extends along the X-direction. The light beams emanating by diffraction at the scale grating 801 propagate to the first scanning grating 803, which is arranged at a distance D (e.g., about 150 mm) from the scale grating 801. The two light beams are straightened by being diffracted at the first scanning grating 803 and propagate to the second scanning grating 805. In the course of this, each of the two light beams passes through two polarization-optical retardation elements 820, 822 or 824, 826 (e.g., ⅛ wave plates) attached to the scanning gratings to create a left circularly polarized and a right circularly polarized light beam. Alternatively, one quarter wave plate could be employed instead of two ⅛ wave plates.

At the second scanning grate 805 the light beams are deflected into +/− first orders of diffraction and propagate to the scale grating 807, which is arranged at a distance D from scanning grate 805. At scale grating 807, the two circularly polarized beams are diffracted such that the beams overlap and propagate along the same path subsequent to passing through the grating 807. A linearly polarized light beam, whose polarization direction is a function of the scale displacement in the measuring direction (X-direction) is created by the super-positioning of the two circularly polarized light beams. The phase shift of the linearly polarized light beam is a function of the displacement of the gratings 801, 807 along the X-direction.

A grating 809 then splits the linearly polarized light beam into three partial beams. Three polarizers 840, 842, 844 are arranged to receive the three different beams, respectively, and are oriented such that incident beams are phase shifted by about 120° with respect to one another. Each of the three phase-shifted beams then is incident on a different photodetector (e.g., either photodetector 830, 832, or 834). Each photodetector then, in turn, generates a detection signal corresponding to the light beam thus detected. The generated signals also are phase-shifted from one another by about 120°. The generated signals then are passed to an electronic processor (e.g., processor 150, 350, or 450) which then can be used to calculate an OPD of the test cavity 808 (e.g., by using known phase shifting interferometry algorithms). In the present implementation, a retro-reflector 802 (e.g., a cube corner reflector) coupled to an adjustable mount is inserted in the path of one of the beams. The position of the retro-reflector then can be adjusted to modify the beam path length in one leg of the test cavity 808, and likewise to adjust the test cavity OPD so that the test cavity OPD is nominally equal to the OPD of the heterodyne cavity 806 (e.g., the difference in OPD between the test and heterodyne cavity is within the source coherence length).

With respect to the test cavity shown in FIG. 8B, illumination is provided from a heterodyne cavity 10 (such as, for example, the heterodyne cavity 406 shown in FIG. 4). Further details of the operation of the device shown in FIG. 8B can be found in U.S. Pat. No. 7,019,842, the contents of which are incorporated herein by reference in their entirety. A modification to that system, however, is that the position of at least one of the scanning gratings (30), ⅛ wave plate (40), and ridge prism (50) is made adjustable. For example, the grating 30, ⅛ wave plate 40, and ridge prism 50 can be fixed to an adjustable mount (not shown) so that the optical path length of the third beam path that includes grating 30, wave plate 40, and ridge prism 50 (and thus the OPD of the test cavity) can be varied.

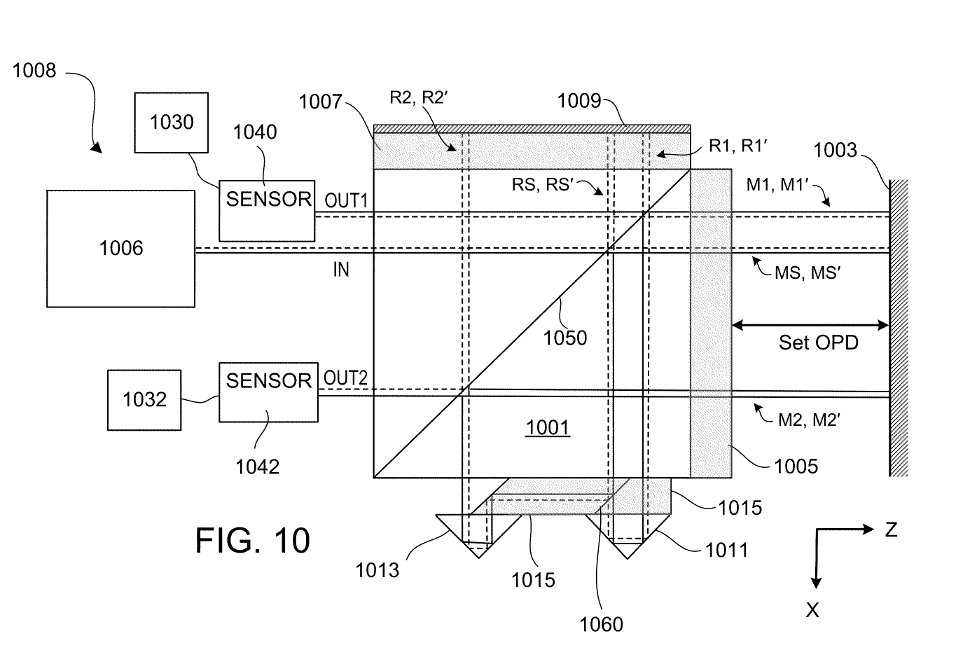

FIG. 9 is a schematic of another example of an encoder head/test cavity geometry that has been modified to operate in conjunction with a low coherence source and a heterodyne cavity. In particular, the test cavity 908 includes an interferometer geometry configured to minimize the optical path errors inherent in the grating fabrication through double diffraction. A description of the design and operation of the interferometer system that included the encoder head of FIG. 9 prior to the modification can be found in U.S. Pat. No. 4,979,826, which is incorporated herein by reference in its entirety.

In FIG. 9, a light beam emitted from a heterodyne cavity (such as, for example, the heterodyne cavity 406 shown in FIG. 4) is divided into two beam s (light beam (a) and light beam (b)) by a beam splitter 901. Light beam (a) passes through the beam splitter 901 and is reflected by a mirror 903 toward a point 0 on an encoder scale 905 at an angle of incidence θ₁ with respect to a normal to the encoder scale surface. Light beam (b), on the other hand, is reflected by the beam splitter 901 and by a mirror 907 toward a retro-reflector 902 (e.g., a cube corner reflector). Retro-reflector 902 then redirects the light beam (b) toward point 0 also at an angle of incidence θ₁. Light beam (a) is diffracted by encoder scale 905 into different diffraction orders (e.g., a +1 order diffracted beam, a 0 order diffracted beam, and a −1 order diffracted beam). Of those diffracted orders, the −1 order diffracted light beam −1(a) emerges from the encoder scale 905 at an angle θ₂, and is reflected by mirrors 911 and 909 back to point 0 on encoder scale 905. Light beam (b) also is diffracted by encoder scale 905 into different diffraction orders. Of the different order beams produced by diffraction of beam (b), the +1 order diffracted light beam +1(b) emerges from the encoder scale 905 at an angle θ₂, and is reflected by the mirrors 909 and 911 back toward point 0 on the encoder scale 905. The reflecting optical system comprising the mirrors 909 and 911 is disposed so that the two light beams, −1(a) and +1(b), each travel in opposite directions on a common optical path and re-enter the point 0 at an angle θ₂.

The light beam −1(a) is again diffracted into multiple different re-diffracted orders. Of those re-diffracted beams, the −1 order, −1×2(a), emerges from the point 0 on the encoder scale 905 perpendicular to the grating surface of the scale 905. Similarly, the light beam +1(b) is again diffracted into multiple re-diffracted orders. Of those re-diffracted beams, the +1 order, +1×2(b), emerges from the point 0 on the encoder scale 905 perpendicular to the grating surface of the scale 905. The light beam −1×2(a) and the light beam +1×2(b) emerge in the same direction from the common point 0 and their optical paths overlap each other such that light beams −1×2(a) and +1×2(b) interfere with each other and provide an interference light signal upon being detected by photodetector 913. The light beam −1×2(a) corresponds to a beam that has been twice subjected to −1st-order diffraction by encoder scale 905. The phase of light beam −1×2(a) is thus delayed per the amount of relative movement x of the encoder scale 905 in either direction of arrow 920 by φₐ. Likewise, the phase of the light beam +1×2(b) is advanced by φ_{b}, per the amount of relative movement x of the diffraction scale 905 in either direction of arrow 920. The interference signal produced by the interference of the two light beams at photodetector 913 is passed to an electronic processor (e.g., such as electronic processor 150, 350, or 450), which can extract the phase of the interference signal. By using the output from the heterodyne cavity and incorporating the mirror 907 and retro-reflector 902, one of the two beam's optical path length can be changed to produce a cavity OPD that nominally matches the heterodyne cavity OPD within a coherence length of the illumination source.

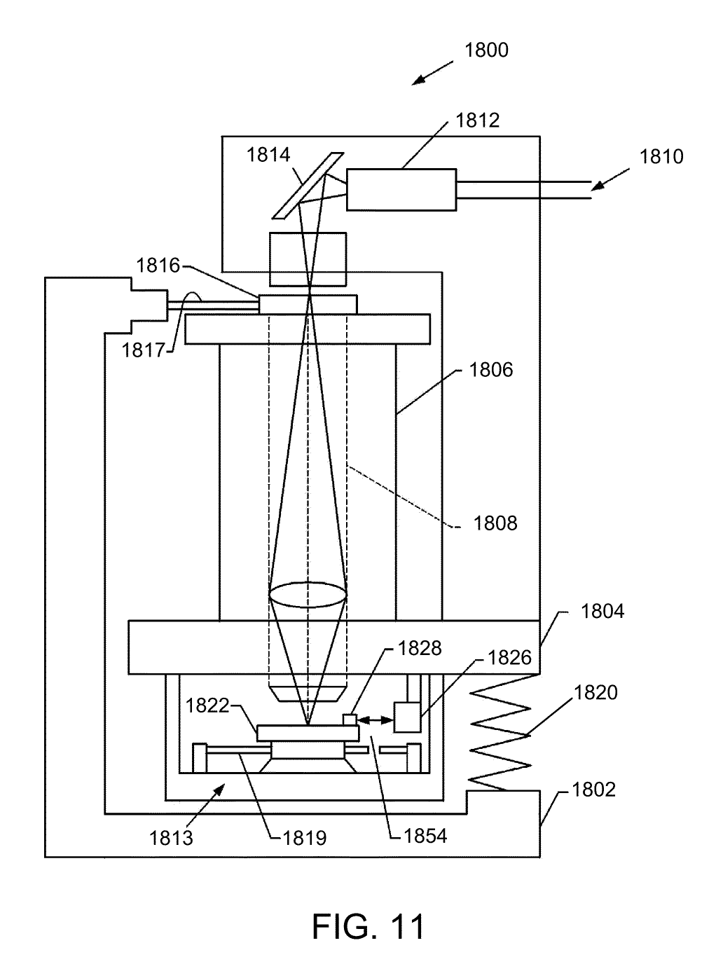

The beam path configuration shown in FIG. 3 above also can be applied to distance measuring interferometers as well, such as, for example, plane mirror interferometers (PMI), high stability PMI's, and differential PMI's. For example, FIG. 10 is a schematic showing a cross-section view of an example of a multiple channel distance measuring interferometer with a common reference path that has been modified to operate in conjunction with a low coherence source and a heterodyne cavity. A description of the design and operation of the multiple channel distance measuring interferometer prior to the modification shown in FIG. 10 can be found in U.S. Pat. No. 7,224,466, the contents of which are incorporated herein by reference in their entirety.

The system 1008 includes a beam-splitter 1001, whose position relative to a measurement reflector 1003 on a test object can be modified. In other words, the test cavity corresponds to the area between a measurement reflector 1003 (e.g., a mirror) and a quarter wave-plate 1005, in which the distance between reflector 1003 and wave-plate 1005 is adjustable. Thus, the optical path length of beams traveling in the system 1008 can be altered such that the OPD of the test cavity 1008 is nominally the same as the OPD of heterodyne cavity 1006.

In addition to beam-splitter 1001, reflector 1003, and quarter wave-plate 1005, the system 1008 also includes quarter-wave plate 1007, a reference reflector 1009 (e.g., mirror), retro-reflectors 1011 and 1013 (e.g., cube corner reflectors), and beam-splitting optics 1015. The heterodyne output from heterodyne cavity 1006 corresponds to input beam IN, which includes two components having orthogonal linear polarizations (dashed and solid lines). Though reference reflector 1009 is shown in FIG. 10 as fixed to quarter wave-plate 1007, and thus also to beam-splitter 1001, reflector 1009 also can be disposed separately on, for example, an adjustable mount.

Polarizing beam splitter 1001 splits the components of input beam IN according to linear polarization to generate a shared measurement beam and a shared reference beam. The measurement beam and reference beam are referred to as “shared” because two separate output channels are created using the arrangement shown in FIG. 10, from which tilt also can be measured. The shared measurement beam is the polarization component of input beam IN that polarizing beam splitter 1001 initially transmits toward quarter-wave plate 1005, and the shared reference beam is the polarization component of input beam IN that polarizing beam splitter 1001 initially reflects toward quarter-wave plate 1007. The shared measurement beam follows a path MS through quarter-wave plate 1005 to measurement mirror 1003, reflects from measurement mirror 1003, and follows a path MS' back through quarter-wave plate 1005 into polarizing beam splitter 1001. The shared measurement beam is incident normal to measurement mirror 1003, and paths MS and MS' of the shared measurement beam are collinear.

The two passes of the shared measurement beam through quarter-wave plate 1005 have the effect of rotating the polarization of shared measurement beam by 90° causing the shared measurement beam to then reflect from the beam splitter interface 1050 in polarizing beam splitter 1001 toward beam-splitting optics 1015. The shared measurement beam thus passes from polarizing beam splitter 1001 and enters beam-splitting optics 1015.

Polarizing beam splitter 1001 also reflects at interface 1050 a component of input beam IN to create the shared reference beam, which heads along a path RS through quarter-wave plate 1007 to reference mirror 1009. The shared reference beam reflects back along a path RS′ through quarter-wave plate 1007 to return to polarizing beam splitter 1001. The shared reference beam then has the linear polarization that polarizing beam splitter 1001 transmits, and the shared reference beam passes through polarizing beam splitter 1001 to enter beam-splitting optics 1015 substantially collinear with the shared measurement beam.

Beam-splitting optics 1015 split the shared measurement beam and the shared reference beam into individual beams corresponding to the measurement axes. Due to the presence on the beam-splitter 1015 of a non-polarizing coating at the beam-splitting interface 1060, half of the power of the shared measurement beam and half of the power of the shared reference beam thus pass through beam splitter coating and enter a retro-reflector 1011 associated with the first measurement axis. The other halves of the shared measurement and reference beams reflect from the beam splitter coating and subsequently enter a retro-reflector 1013 associated with the second measurement axis.

Retro-reflector 1011 reflects and offsets the individual beam corresponding to the first measurement axis. This first individual beam returns to polarizing beam splitter 1001, which splits, at interface 1050, the first individual beam into a first measurement beam and a first reference beam that are associated with the first measurement axis. The first measurement beam reflects from the polarizing beam splitter interface 1050 in polarizing beam splitter 1001 and heads through quarter-wave plate 1005 along a path M1 to measurement reflector 1003. The first measurement beam then reflects from measurement mirror 1003 and returns to polarizing beam splitter 1001 along a path M1′.

The reflection of the first measurement beam from measurement mirror 1003 introduces an equal but opposite angular error that cancels the variance between the first measurement and reference beams. The first reference beam after traversing paths R1 and R1′ to and from reference mirror 1009 and reflecting from the beam splitter interface 1050 in polarizing beam splitter 1001 is thus parallel to the first measurement path M1′, and the first measurement and reference beams merge to form an output beam OUT1 for the first measurement axis, in which the output beam OUT1 is detected by first detector 1040 (e.g., a photodetector).

The second individual beam reflects from retro-reflector 1013 and enters polarizing beam splitter 1001, where polarizing beam splitter 1001 splits the second individual beam into a second measurement beam and a second reference beam. The second measurement beam follows paths M2 and M2′ to and from measurement reflector 1003, and the second reference beam follows paths R2 and R2′ to and from reference reflector 1009 before the second measurement and reference beams merge to form a second output beam OUT2 corresponding to the second measurement axis, in which the output beam OUT2 is detected by second detector 1042 (e.g., a photodetector).

Measurement electronics 1030 (e.g., an electronic processor), which is coupled to and receives output signals generated by detector 1040 upon detecting the output beam OUT1, measures the frequency difference between the first measurement beam and the first reference beam and calculates any Doppler shift that reflections from measurement mirror 1003 caused in the first measurement beam. This measured Doppler shift includes a component introduced by the reflection of the shared measurement beam (i.e., the reflection from path MS to path MS′) and a component introduced by the reflection of the first measurement beam (i.e., the reflection from path M1 to path M1′). Measurement electronics 1030 thus effectively measures an average of the movement of measurement mirror 1003 at two points, which should be equal to the movement at a point halfway between the two reflections on measurement mirror 1003.

Measurement electronics 1032 (e.g., an electronic processor), which is coupled to and receives output signals generated by detector 1042 upon detecting the output beam OUT2, measures the frequency difference between the second measurement beam and the second reference beam to measure any Doppler shift that reflections from measurement mirror 1003 caused in the second measurement beam. This measured Doppler shift includes the component introduced by the reflection of the shared measurement beam (i.e., the reflection from path MS to path MS′) and a component introduced by the reflection of the second measurement beam (i.e., the reflection from path M2 to path M2′). Measurement electronics 1032 thus effectively measures an average of the movement of measurement mirror 1003 at two points, which should be equal to the movement at a point halfway between the two reflections from measurement mirror 1003.

In general, any of the analysis methods described above, including determining phase information from detected interference signals and degree of freedom information of the encoder scales, can be implemented in computer hardware or software, or a combination of both. For example, in some embodiments, electronic processor 150, 350, 450, 1030, and/or 1032 can be installed in a computer and connected to one or more encoder systems and configured to perform analysis of signals from the encoder systems. Analysis can be implemented in computer programs using standard programming techniques following the methods described herein. Program code is applied to input data (e.g., interferometric phase information) to perform the functions described herein and generate output information (e.g., degree of freedom information). The output information is applied to one or more output devices such as a display monitor. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits preprogrammed for that purpose.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The computer program can also reside in cache or main memory during program execution. The analysis methods can also be implemented as a computer-readable storage medium, configured with a computer program, where the storage medium so configured causes a computer to operate in a specific and predefined manner to perform the functions described herein.

Lithography Tool Applications

Lithography tools are especially useful in lithography applications used in fabricating large scale integrated circuits such as computer chips and the like. Lithography is the key technology driver for the semiconductor manufacturing industry. Overlay improvement is one of the five most difficult challenges down to and below 22 nm line widths (design rules), see, for example, the International Technology Roadmap for Semiconductors, pp. 58-59 (2009).

Overlay depends directly on the performance, i.e., accuracy and precision, of the metrology system used to position the wafer and reticle (or mask) stages. Since a lithography tool may produce $50-100M/year of product, the economic value from improved metrology systems is substantial. Each 1% increase in yield of the lithography tool results in approximately $1M/year economic benefit to the integrated circuit manufacturer and substantial competitive advantage to the lithography tool vendor.

The function of a lithography tool is to direct spatially patterned radiation onto a photoresist-coated wafer. The process involves determining which location of the wafer is to receive the radiation (alignment) and applying the radiation to the photoresist at that location (exposure).

During exposure, a radiation source illuminates a patterned reticle, which scatters the radiation to produce the spatially patterned radiation. The reticle is also referred to as a mask, and these terms are used interchangeably below. In the case of reduction lithography, a reduction lens collects the scattered radiation and forms a reduced image of the reticle pattern. Alternatively, in the case of proximity printing, the scattered radiation propagates a small distance (typically on the order of microns) before contacting the wafer to produce a 1:1 image of the reticle pattern. The radiation initiates photo-chemical processes in the resist that convert the radiation pattern into a latent image within the resist.

To properly position the wafer, the wafer includes alignment marks on the wafer that can be measured by dedicated sensors. The measured positions of the alignment marks define the location of the wafer within the tool. This information, along with a specification of the desired patterning of the wafer surface, guides the alignment of the wafer relative to the spatially patterned radiation. Based on such information, a translatable stage supporting the photoresist-coated wafer moves the wafer such that the radiation will expose the correct location of the wafer. In certain lithography tools, e.g., lithography scanners, the mask is also positioned on a translatable stage that is moved in concert with the wafer during exposure.

Encoder systems, such as those discussed previously, are important components of the positioning mechanisms that control the position of the wafer and reticle, and register the reticle image on the wafer. If such encoder systems include the features described above, the accuracy of distances measured by the systems can be increased and/or maintained over longer periods without offline maintenance, resulting in higher throughput due to increased yields and less tool downtime.

In general, the lithography tool, also referred to as an exposure system, typically includes an illumination system and a wafer positioning system. The illumination system includes a radiation source for providing radiation such as ultraviolet, visible, x-ray, electron, or ion radiation, and a reticle or mask for imparting the pattern to the radiation, thereby generating the spatially patterned radiation. In addition, for the case of reduction lithography, the illumination system can include a lens assembly for imaging the spatially patterned radiation onto the wafer. The imaged radiation exposes resist coated onto the wafer. The illumination system also includes a mask stage for supporting the mask and a positioning system for adjusting the position of the mask stage relative to the radiation directed through the mask. The wafer positioning system includes a wafer stage for supporting the wafer and a positioning system for adjusting the position of the wafer stage relative to the imaged radiation. Fabrication of integrated circuits can include multiple exposing steps. For a general reference on lithography, see, for example, J. R. Sheats and B. W. Smith, in Microlithography: Science and Technology (Marcel Dekker, Inc., New York, 1998), the contents of which is incorporated herein by reference.

Encoder systems described above can be used to precisely measure the positions of each of the wafer stage and mask stage relative to other components of the exposure system, such as the lens assembly, radiation source, or support structure. In such cases, the encoder system's optical assembly can be attached to a stationary structure and the encoder scale attached to a movable element such as one of the mask and wafer stages. Alternatively, the situation can be reversed, with the optical assembly attached to a movable object and the encoder scale attached to a stationary object.

More generally, such encoder systems can be used to measure the position of any one component of the exposure system relative to any other component of the exposure system, in which the optical assembly is attached to, or supported by, one of the components and the encoder scale is attached, or is supported by the other of the components.

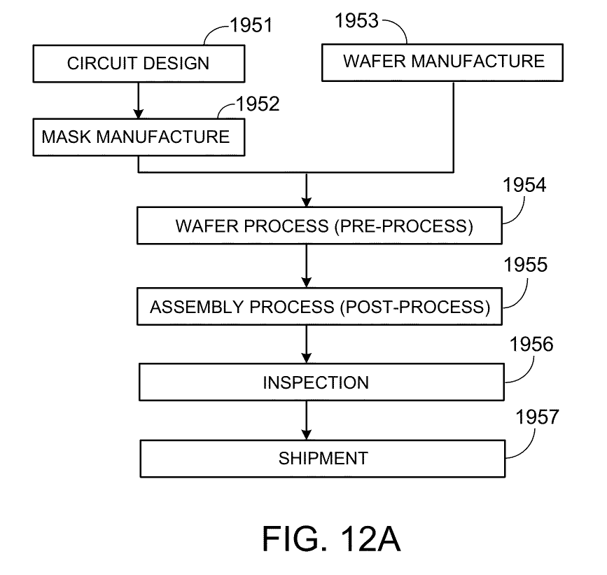

An example of a lithography tool 1800 using an interferometry system 1826 is shown in FIG. 11. The encoder system is used to precisely measure the position of a wafer (not shown) within an exposure system. Here, stage 1822 is used to position and support the wafer relative to an exposure station. Scanner 1800 includes a frame 1802, which carries other support structures and various components carried on those structures. An exposure base 1804 has mounted on top of it a lens housing 1806 atop of which is mounted a reticle or mask stage 1816, which is used to support a reticle or mask. A positioning system for positioning the mask relative to the exposure station is indicated schematically by element 1817. Positioning system 1817 can include, e.g., piezoelectric transducer elements and corresponding control electronics. Although, it is not included in this described embodiment, one or more of the encoder systems described above can also be used to precisely measure the position of the mask stage as well as other moveable elements whose position must be accurately monitored in processes for fabricating lithographic structures (see supra Sheats and Smith Microlithography: Science and Technology).

Suspended below exposure base 1804 is a support base 1813 that carries wafer stage 1822. Stage 1822 includes a measurement object 1828 for diffracting a measurement beam 1854 directed to the stage by optical assembly 1826. A positioning system for positioning stage 1822 relative to optical assembly 1826 is indicated schematically by element 1819. Positioning system 1819 can include, e.g., piezoelectric transducer elements and corresponding control electronics. The measurement object diffracts the measurement beam reflects back to the optical assembly, which is mounted on exposure base 1804. The encoder system can be any of the embodiments described previously.

During operation, a radiation beam 1810, e.g., an ultraviolet (UV) beam from a UV laser (not shown), passes through a beam shaping optics assembly 1812 and travels downward after reflecting from mirror 1814. Thereafter, the radiation beam passes through a mask (not shown) carried by mask stage 1816. The mask (not shown) is imaged onto a wafer (not shown) on wafer stage 1822 via a lens assembly 1808 carried in a lens housing 1806. Base 1804 and the various components supported by it are isolated from environmental vibrations by a damping system depicted by spring 1820.

In some embodiments, one or more of the encoder systems described previously can be used to measure displacement along multiple axes and angles associated for example with, but not limited to, the wafer and reticle (or mask) stages. Also, rather than a UV laser beam, other beams can be used to expose the wafer including, e.g., x-ray beams, electron beams, ion beams, and visible optical beams.

In certain embodiments, the optical assembly 1826 can be positioned to measure changes in the position of reticle (or mask) stage 1816 or other movable components of the scanner system. Finally, the encoder systems can be used in a similar fashion with lithography systems involving steppers, in addition to, or rather than, scanners.

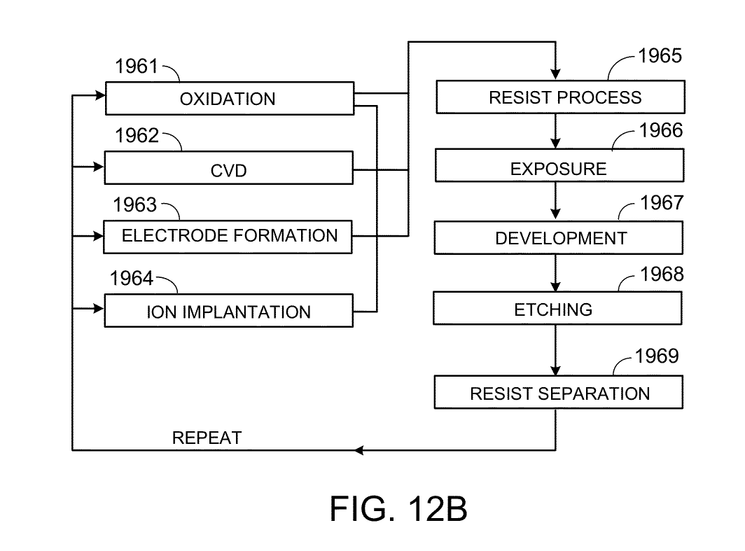

As is well known in the art, lithography is a critical part of manufacturing methods for making semiconducting devices. For example, U.S. Pat. No. 5,483,343 outlines steps for such manufacturing methods. These steps are described below with reference to FIGS. 12A and 12B. FIG. 12A is a flow chart of the sequence of manufacturing a semiconductor device such as a semiconductor chip (e.g., IC or LSI), a liquid crystal panel or a CCD. Step 1951 is a design process for designing the circuit of a semiconductor device. Step 1952 is a process for manufacturing a mask on the basis of the circuit pattern design. Step 1953 is a process for manufacturing a wafer by using a material such as silicon.

Step 1954 is a wafer process that is called a pre-process in which, by using the so prepared mask and wafer, circuits are formed on the wafer through lithography. To form circuits on the wafer that correspond with sufficient spatial resolution those patterns on the mask, interferometric positioning of the lithography tool relative the wafer is necessary. The interferometry methods and systems described herein can be especially useful to improve the effectiveness of the lithography used in the wafer process.

Step 1955 is an assembling step, which is called a post-process in which the wafer processed by step 1954 is formed into semiconductor chips. This step includes assembling (dicing and bonding) and packaging (chip sealing). Step 1956 is an inspection step in which operability check, durability check and so on of the semiconductor devices produced by step 1955 are carried out. With these processes, semiconductor devices are finished and they are shipped (step 1957).

FIG. 12B is a flow chart showing details of the wafer process. Step 1961 is an oxidation process for oxidizing the surface of a wafer. Step 1962 is a CVD process for forming an insulating film on the wafer surface. Step 1963 is an electrode forming process for forming electrodes on the wafer by vapor deposition. Step 1964 is an ion implanting process for implanting ions to the wafer. Step 1965 is a resist process for applying a resist (photosensitive material) to the wafer. Step 1966 is an exposure process for printing, by exposure (i.e., lithography), the circuit pattern of the mask on the wafer through the exposure apparatus described above. Once again, as described above, the use of the interferometry systems and methods described herein improve the accuracy and resolution of such lithography steps.

Step 1967 is a developing process for developing the exposed wafer. Step 1968 is an etching process for removing portions other than the developed resist image. Step 1969 is a resist separation process for separating the resist material remaining on the wafer after being subjected to the etching process. By repeating these processes, circuit patterns are formed and superimposed on the wafer.

The encoder systems described above can also be used in other applications in which the relative position of an object needs to be measured precisely. For example, in applications in which a write beam such as a laser, x-ray, ion, or electron beam, marks a pattern onto a substrate as either the substrate or beam moves, the encoder systems can be used to measure the relative movement between the substrate and write beam.

A number of embodiments have been described. Nevertheless, it will be understood that various modifications may be made without departing from the spirit and scope of the invention. Other embodiments are within the scope of the following claims.

What is claimed is:

1. A method for determining information about changes in a position of an encoder scale, the method comprising:
separating, in a first interferometry cavity, a low coherence beam into a first beam propagating along a first path of the first interferometry cavity and a second beam propagating along a second path of the first interferometry cavity;
combining the first beam and the second beam to form a first output beam;
separating, in a second interferometry cavity, the first output beam into a measurement beam propagating along a measurement path of the second interferometry cavity and a reference beam propagating along a reference path of the second interferometry cavity;
combining the measurement beam and the reference beam to form a second output beam;
detecting an interference signal based on the second output beam; and
determining the information about changes in the position of the encoder scale based on phase information from the interference signal.

2. The method of claim 1, further comprising adjusting an optical path difference (OPD) associated with the second interferometry cavity.

3. The method of claim 2, wherein adjusting the OPD associated with the second interferometry cavity comprises setting the OPD associated with the second interferometry cavity approximately equal to an OPD associated with the first interferometry cavity.

4. The method of claim 3, wherein a difference between the OPD associated with the second interferometry cavity and the OPD associated with the first interferometry cavity is less than or equal to a coherence length of the low coherence beam.

5. The method of claim 3, wherein adjusting the OPD associated with the second interferometry cavity comprises adjusting an optical path length (OPL) of at least one of the measurement path or the reference path.

6. The method of claim 4, wherein each of the OPD associated with first cavity and the OPD associated with the second cavity is greater than a coherence length of the low coherence beam.

7. The method of claim 3, wherein the OPD of the first cavity is equal to a difference between an optical path length (OPL) of the first path and an OPL of the second path, the OPL of the second path being different from the OPL of the first path.

8. The method of claim 1, further comprising directing the measurement beam toward the encoder scale prior to combining the measurement beam and the reference beam, wherein the measurement beam diffracts from the encoder scale at least once.

9. The method of claim 1, further comprising shifting a frequency of at least one of the first beam or the second beam in the first interferometry cavity.

10. The method of claim 9, wherein the second output beam comprises a heterodyne frequency, the heterodyne frequency being equal to a difference between the frequency of the first beam and the frequency of the second beam after shifting the frequency of at least one of the first beam or the second beam.

11. An interferometry system comprising:
a low coherence illumination source;
a first interferometer cavity coupled to the low coherence illumination source to receive an output of the illumination source, the first interferometer cavity being associated with a first optical path difference (OPD); and
a second interferometer cavity coupled to the first interferometer cavity to receive an output of the first interferometer cavity, the second interferometry cavity being associated with a second OPD.

12. The interferometry system of claim 11, wherein the first OPD is constant.

13. The interferometry system of claim 11, wherein the second OPD is adjustable.

14. The interferometry system of claim 11, wherein a difference between the first OPD and the second OPD is less than a coherence length (CL) of an output of the low coherence illumination source.

15. The interferometry system of claim 11, wherein each of the first OPD and the second OPD is greater than a coherence length (CL) of the output of the illumination source.

16. The interferometry system of claim 11, wherein the first OPD is approximately equal to the second OPD.

17. The interferometry system of claim 11, wherein the first cavity comprises a first leg having a first optical path length (OPL) and a second leg having a second different OPL, the OPD of the first cavity being equal to the difference between the first OPL and the second OPL.

18. The interferometry system of claim 11, wherein the first cavity comprises a frequency shifting device in the first leg, the frequency shifting device being configured to shift a frequency of light in the first leg during operation of the interferometry system.

19. The interferometry system of claim 18, wherein the frequency shifting device comprises an acousto-optical modulator or an electro-optical phase modulator.

20. The interferometry system of claim 11, wherein the second cavity comprises a first leg having a first optical path length (OPL) and a second leg having a second OPL, the OPD of the second cavity being equal to a difference between the first OPL and the second OPL.

21. The interferometry system of 20, wherein at least one of the first OPL and the second OPL is adjustable.

22. The interferometry system of claim 20, wherein the first leg corresponds to a measurement path and the second leg corresponds to a reference path.

23. The interferometry system of claim 20, wherein the second cavity comprises a diffractive encoder scale, each of the first OPL and the second OPL being defined with respect to a position of the encoder scale.

24. The interferometry system of claim 11, further comprising a photodetector and an electronic processor, the electronic processor being configured to derive heterodyne phase information from a signal detected by the photodetector during operation of the interferometry system.

25. The interferometry system of claim 24, wherein the second cavity comprises a diffractive encoder scale, and wherein the electronic processor is configured to obtain position information about a degree of freedom of the encoder scale based on the heterodyne phase information during operation of the interferometry system.
